(19) United States
(12) Patent Application Publication
(10) Pub. No.: US 2025/0278344 A1
(43) Pub. Date: Sep. 4, 2025

(54) MAINTENANCE WINDOW AWARE REPORTING

(71) Applicant: Selector Software, Inc., Santa Clara, CA (US)

(72) Inventors: Surya Chandra Sekhar Nimmagadda, Santa Clara, CA (US); Nitin Kumar, Santa Clara, CA (US); Mariam Aafreen, Santa Clara, CA (US)

(21) Appl. No.: 18/592,620

(22) Filed: Mar. 1, 2024

(51) Int. Cl. G06F 11/34; G06F 16/2457

(52) U.S. Cl. CPC G06F 11/3409; G06F 16/24573

(57) ABSTRACT

Systems, apparatuses, and methods for maintenance aware performance reporting are disclosed. Responsive to a request for a performance report of devices and/or services for a given time range, reportable data is computed. Checks are performed to identify any maintenance windows that need to be configured in that time range. If such windows are to be configured, the performance insights for the entity are modified, without requiring to perform a reanalysis of their entire performance data. This is performed by utilizing metadata defining the performance insights, that are maintained along with performance stored in individual time-based datasets. Based on these modifications, updated performance reports can be created on-the-fly accounting for previously scheduled but unreported events. Further, the update is performed without reanalysis of original data, thereby maintaining efficiency and accuracy of the reports.

### BACKGROUND

### Description of the Related Art

Performance management systems are frequently utilized to assist in overseeing the performance of computing environments that support one or multiple software applications or their hardware components. This involves analyzing the inputs (user requests), outputs (responses to user requests), and the utilization of resources within a computing environment while anticipating relevant performance-related metrics. These resources encompass infrastructure elements like compute power (CPU), memory (RAM), storage (disk/files), as well as application-specific resources such as database connections and application threads.

In performance management systems, reporting is an important aspect, as it drives actions needed to correct or mitigate a faulty entity. During operations, it is quite common that few entities may be in a downtime for known reasons, e.g., scheduled maintenance. However, these maintenance operations for the entity may not be updated in real-time. Another scenario could include a human error, wherein an entity is incorrectly configured for a maintenance operation, when there is none scheduled.

Generally, in order to account for incorrect flagging of devices for maintenance, and/or add missing maintenance operations during reporting, data for generating reports is to be recalibrated, which at least involves recalculation of the initial performance metric data. However, recalibration is not only time consuming, but can introduce further errors in the reporting since data needs to be recomputed and reanalyzed. In view of the above, improved systems and methods for maintenance-aware reporting are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of an exemplary network implementation of an operations monitoring system.

FIG. 2 is a block diagram of exemplary implementation of various units of the operations monitoring system.

FIG. 3 is a block diagram illustrating aggregation of performance data for maintenance-aware reporting.

FIG. 4 is a block diagram illustrating generation of performance reports for entities under surveillance.

FIG. 5 is a block diagram illustrating modification of report content based on

maintenance window configuration.

FIG. 6 illustrates a method for maintenance-aware performance reporting.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for maintenance aware performance reporting are disclosed. Performance reports can be generated to enable an end-user to view performance parameters associated with services and devices being monitored, either on-site or remotely. In one implementation, content of the generated reports must be produced in a manner such that a time period for which a report is generated considers all maintenance activity during the time period. However, there may be situations wherein intimation of a maintenance activity for a given service or device, is updated in the system later than the actual time the activity occurs. Further, since performance data is recorded and analyzed in real or near-real time, such maintenance activity can remain unaccounted, when reports for the service or device are generated. To avoid such false positives, it is important to allow for configuring maintenance windows at a later point of time than they actually occur, thereby allowing for generation of reports that accurately account for these maintenance activities.

In one or more implementations, when a performance report over a time range is requested, reportable data can be computed. Checks are performed to identify any events (e.g., previously performed but unreported maintenance activities) that need to be configured in that time range. If such events are to be configured, the affected devices within the requested time range are identified and performance insights for these devices are modified, without requiring to perform a reanalysis of their entire performance data. This can be efficiently done, since metadata defining the performance parameters for the devices are maintained, in the form of intermediate time-based datasets. Based on these modifications, final reportable data is computed. This aids in creating accurate performance reports “on-the-fly” accounting for any previously scheduled but unreported maintenance activities. Further, since the update is done without recreation of the entire report, efficiency and accuracy of report generation is maintained. These and other implementations are discussed.

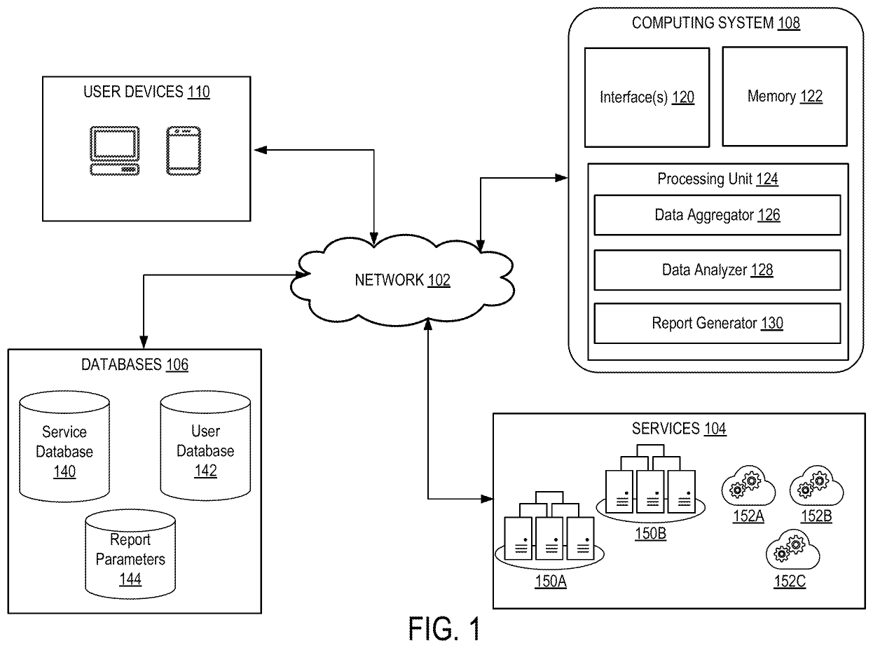

FIG. 1 illustrates an exemplary network implementation 100 for functioning of a computing system 108 (alternatively referred to as operations management system or OMS 108). In an implementation, the OMS 108 is configured to manage operations and maintenance of one or more services 104, over a network 102. In one implementation, services 104 managed by the OMS 108 can include one or more physical infrastructures, e.g., datacenter 150A and datacenter 150B (collectively referred to as datacenters 150). Further, the services 104 can include software services, e.g., cloud-based services 152A, 152B, and 152C (collectively referred to as cloud services 152). In an example, datacenters 150 may include on-site datacenters such as Information Technology (IT) equipment, such as computers, networks, and storage systems, and are located and used to support the operation of a particular business. The equipment in the datacenters 150 can be used to run important applications, services, and store critical data for the business. Similarly, cloud services 152 include services that may allow businesses to access and use IT resources, such as applications, development platforms, servers, storage, and virtual desktops, over the internet or a dedicated network. Other examples of services 104 are contemplated.

The OMS 108 is configured to provide analysis of the workings of the services 104 to one or more user devices 110 over the network 102. In one example, the user devices 110 include devices used by IT administrators, network engineers, and/or maintenance personnel to inspect performance of the services 104, either on-site or remotely. User devices 110 can include personal computers, digital assistants, smartphones, tablets, and laptops, can be connected to the network 102 or operate independently. These devices may also have various external or internal components, like a mouse, keyboard, or display. User devices 110 can run a variety of applications, such as word processing, email, and internet browsing, and can be compatible with different operating systems like Windows or Linux.

The OMS 108 is further connected to one or more databases 106, over the network 102, such that data generated as a result of execution of instructions by the OMS 108, is stored in at least one of the databases 106. In one implementation, the databases 106 can be internal to the OMS 108. The databases 106 at least comprise a service database 140, a user database 142, and a report parameters database 144. The service database 140, in an implementation, can be used to store data associated with one or more of the services 104. The data can include business data, location data, equipment data, maintenance data, and the like for one or more services 104. The user database 142, in an implementation, stores data associated with users of the user devices 110. The data can include user registration data, device-type data, user designation data, and the like. Further, report parameters database 144 can store data pertaining to reporting parameters such as performance metrics, user analysis, anomaly detection, root cause analysis, and the like, associated with the services 104. In one implementation, the OMS 108 is configured to generate performance reports for the services 104 (on-demand and/or in a scheduled manner) based on the reporting parameters.

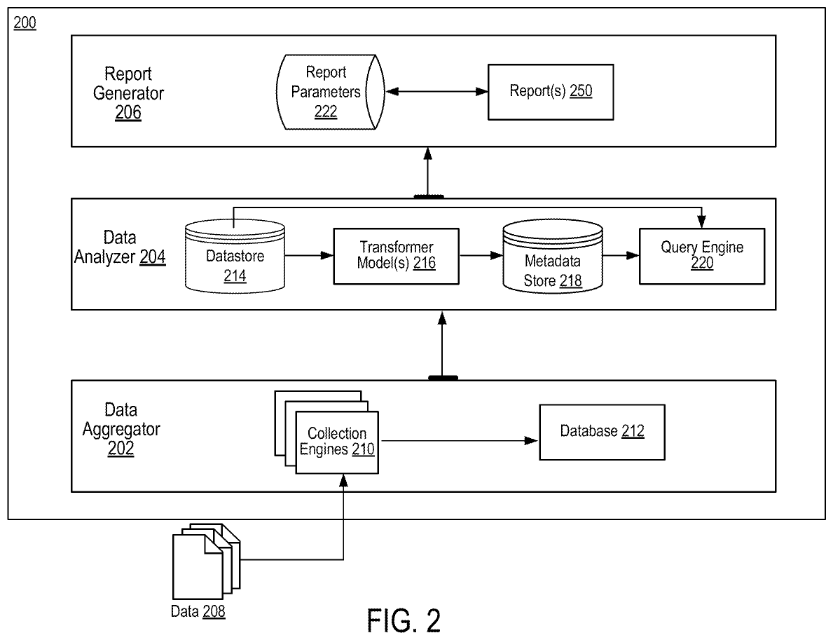

As shown in the figure, the operations management system 108 comprises one or more interface(s) 120, a memory 122, and a processing unit 124. In an implementation, the one or more interface(s) are configured to display data generated as a result of the processing unit 124 executing one or more programming instructions stored in the memory 122. The processing unit 124 further comprises data aggregator 126, data analyzer 128, and report generator 130. The data aggregator 126 is configured to ingest data associated with one or more service of the services 104, from a variety of data sources (as detailed in FIG. 2). In an implementation, the ingested data is indicative of operational parameters of the services 104 being monitored. The data, in an example, can include information pertaining to performance metrics, events, logs, anomalies, and the like. In an implementation, the data is heterogenous, in that, the content as well as the format of the data is non-consistent. The data aggregator 126 is configured to ingest such heterogenous data from multiple data sources, such as, network management interface data, data services pipeline data, time-series data, and the like. The data can also include data from existing data logging and information technology (IT) monitoring systems. In an implementation, data from each different data source is collected by the data aggregator 126 using one or more data collection engines. The collected data is processed and can be stored by the data aggregator 126, e.g., in the service database 140.

The data analyzer 128 analyzes the collected data and provides an abstract view of the data, for example, by decoupling the data from its source. In an implementation, the abstract view of the data by decoupling of data can be facilitated by the use of virtual machines and/or containers. The decoupled data can then be normalized by the data analyzer 128 and redirected to specific storage repositories (not shown), created for each type of data. The decoupled and normalized data, in an implementation, is utilized by the data analyzer 128 to generate metadata associated with a plurality of performance metrics for inspection of one or more services 104, in real-time or near-real time. In an implementation, the metadata is generated in the form of labels, such that the collected data, when infused with these labels, can be cross-correlated to monitor performance metrics of the one or more services 104.

The report generator 130, in an implementation, is configured to generate on-demand or scheduled performance reports, e.g., to be provided for display on one or more graphical user interfaces of the user devices 110. The reports can facilitate a user of a given user device 110 (such as an IT administrator), to access an overall view of one or more services 140 based on their performance metrics over a period of time.

In various implementations, the report generator 130 is configured to check (periodically or on-demand) for maintenance windows that need to be configured for maintenance activities that were unreported at a time these activities occurred, but were later reported to the OMS 108. For instance, when a report is requested for a duration T1 to T2, the report generator 130 checks for any maintenance windows that need to be configured, e.g., for maintenance activities that were performed between T1 and T2, but were reported later than T2. If such a maintenance activity is identified, the report generator 130 can adjust the performance metrics for the duration of the maintenance activity, e.g., just before the report is generated for that duration. This way, performance reports can be adjusted for accounting of unreported maintenance operations in an after the fact manner, thereby avoiding reporting of skewed performance metrics. Further, each time such windows are configured, a user device(s) can be notified of the changes in the performance metrics, such that a personnel can make informed decisions. These and other implementations are described in detail with respect to the description that follows.

Turning now to FIG. 2, a block diagram of exemplary implementation of various units of an operations management system 200 (or “OMS 200”) is illustrated. For the sake of brevity, FIG. 2 describes the detailed working of a data aggregator 202, a data analyzer 204, and a report generator 206, of the OMS 200. Other processing and non-processing units of the OMS are similar to that described for computing system 108 in FIG. 1.

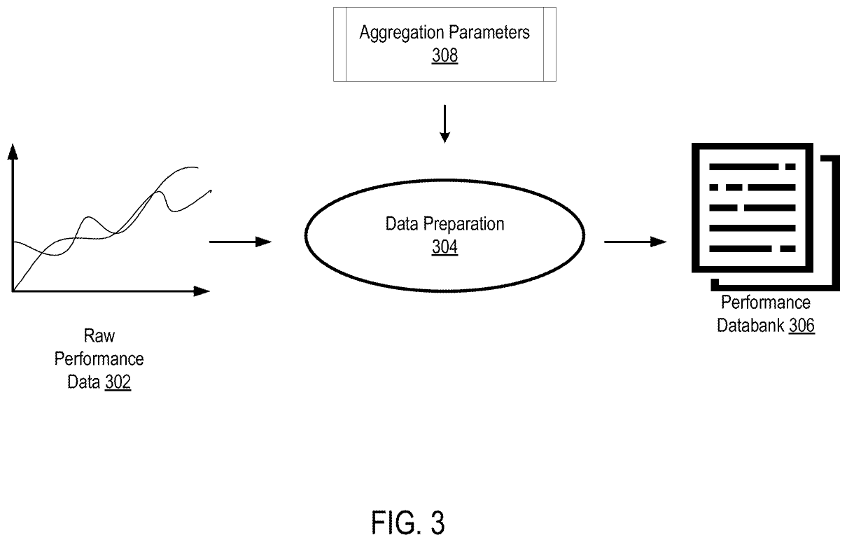

In an implementation, the OMS 200 can have access to a variety of data sources (as shown in FIG. 3), such that the data aggregator 202 ingests data 208 from these data sources using a set of custom-built collection engines 210. The collection engines 210, in several implementations, can be configured for ingesting data 208 from one or more data sources (not shown), either by pulling data 208 from the data sources or using push notifications to collect data 208 from the data sources.

In an example, the one or more data sources can include IT monitoring and data logging systems. In an implementation, data aggregator comprises pre-integrated collection engines 210 for each different type of data source, such that heterogenous data 208 from varied data sources can be easily collected for analysis. In one implementation, data 208 can also be collected directly from one or more computing devices being monitored. As used hereinafter, “computing device” is meant to include devices and/or services under surveillance by an operations management system, until otherwise specified. The “computing device” in this context can include one or more physical datacenters, software services, network devices, optical transceivers, various network interfaces, network links, routers, and other computing infrastructure.

In an implementation, the data aggregator 202 can connect to existing inventory or Configuration Management Database (CMDB) tool associated with a computing device being monitored. According to the implementation, the data 208 collected from such tools can include static inventory definitions from a file or dynamic definitions via an Application Programming Interface (API). The data aggregator 202 can also integrate with an existing instance of such a tool (e.g., Netbox instance, etc.) and/or provide inventory as a service using an internal Netbox instance (not shown).

The collected data 208, is used to create a database 212, such that data from the database 212 can be used by one or more components of the OMS 200 for real-time telemetry and enrichment. Further, each collection engine 210, in an implementation, can be cloud-native, such that scaling out of the collection engines 210 for new types of data 208 is possible. The collection engines 210 are configured to provide an entry point for ingestion of data into the OMS 200. Different types of data 208 ingested from the collection engines 210 can include network management interface data, data from data pipeline services, time series data, representational state transfer (REST API) data, monitoring tool data, and the like.

In an implementation, the data analyzer 204 is configured to access different sets of data from the database 212, store the sets of data in datastore 214, and process the data, e.g., using one or more transformer models 216. In an implementation, each different set of data may represent heterogenous data of different types (e.g., collected from different data sources), such as metrics, events, logs, configurations, operational states, and the like. The data analyzer 204 is configured to process the sets of data to normalize the data contained therein and decouple the data from their respective data sources. That is, the data is processed to render the data source agnostic so as to facilitate extraction, enrichment, and redirection of said data to appropriate storage repositories (not shown), for each different type of data.

In one implementation, the processed data is further analyzed by the data analyzer 204 to generate metadata. The collected data 208, in one example, may lack context and therefore enrichment of the data 208 with context-based metadata may be required. The normalized and decoupled data is fed into one or more transformer models 216 to generate contextual metadata. The metadata is stored in a metadata store 218. In an implementation, the metadata is created in the form of labels, such that processed data can be correlated to create performance parameters indicative of performance of one or more computing devices being monitored. In an implementation, the performance data can include information pertaining to anomalies, events, logs, errors, warnings, and the like for computing devices under surveillance. Further, the performance parameters indicative of the performance of the computing device can include parameters such as device health, device remaining life, device peer rating, device performance rating, and the like.

In one implementation, the metadata is generated in a manner that it represents performance parameters generated as a result of analyzing the performance data of any given computing device. The data analyzer 204, in one implementation, is configured to group the performance parameters (correlated with analyzed performance data), in a performance databank (e.g., databank 306 in FIG. 3), such that granularity of the metadata is maintained for each performance parameter. As used hereinafter “performance databank” refers to a datastore including multiple individual datasets, each storing performance parameters correlated with device information and performance data, and corresponding to equal predetermined time durations (e.g., 30 minutes or 1 hour). Further, the granularity of the metadata is maintained in each individual dataset, such that performance parameters can be identified in each dataset using the metadata, even when analyzed data is segregated into smaller portions, e.g., based on predetermined time intervals.

In an implementation, analyzed performance data correlated with performance parameters can be utilized by the OMS 200 to create dashboards for display on a user device GUI (not shown). In an implementation, the dashboards can include performance reports 250 associated with various computing devices. The performance reports 250 include information on performance parameters, as well as one or more events, anomalies, errors, warnings, etc. associated with the computing devices under surveillance. According to the implementation, these performance reports 250 can be transmitted to a user device to enable an end-user to access details about performance of computing devices being monitored, either on-site or remotely.

In one implementation, content of the generated reports 250 must be produced in a manner such that a time period for which a report is generated considers all events (e.g., maintenance, shutdown, replacements, etc.) associated with the computing devices during the time period. However, in various implementations, there may be situations wherein intimation of an event associated a given computing device, is unavailable at the time performance data for the computing device is being processed and analyzed by the system. For example, the event(s) can be updated in the system later than the actual time the event occurs. In another example, an event that is recorded in the system can remain unperformed owing to various reasons (e.g., erroneous scheduling). Since performance data is recorded and analyzed in real or near-real time, such events can remain unaccounted for, when reports 250 for the computing device are requested. To avoid such false positives, it is important for the system to be able to configure (or otherwise modify) events at a later point of time than they actually occur, thereby allowing for generation of reports that are up to date and accurate.

In one implementation, generation of the performance databank allows the ability to store performance data, over a long period of time, without losing the granularity of metadata that represent associated performance parameters. Since the granularity of metadata is maintained, the metadata can be correlated with events configured at a later point of time. For example, when a user device requests a performance report 250 over a time range, the report generator 206 can check for any events (e.g., previously performed but unreported maintenance activities) that need to be configured within that time range. If such windows are to be configured, the report generator 206 can identify affected computing devices, i.e., devices associated with the events, and modify performance parameters for these devices, without requiring to perform a reanalysis of their entire performance data. This can be efficiently done, since the metadata defining the performance parameters is maintained in individual datasets of the performance databank. Based on these modifications, reportable data is computed. That is, the reportable data can be generated “on-the-fly” for any events that were unreported or erroneously scheduled. Further, since the update is done without reanalysis of the entire performance data, efficiency and accuracy of report generation is maintained. In one implementation, the reportable data is generated using report parameters 222, that can include such as performance metrics, user analysis, anomaly detection, root cause analysis, and the like, associated with the computing devices under analysis.

Based on the computed reportable data, as well as accounting for any adjustments to be made in the reportable data, the report generator 206 generates the performance report(s) 250. Further, information corresponding to the events, for which adjustments have been made, can be specifically added to the report(s) 250. For example, performance parameters adjusted for computing devices can be highlighted. In another example, a comparison can be illustrated to clearly depict the changes in the performance parameters when considering an event, and performance parameters when the event is not considered. Additionally, information about the events (e.g., type of maintenance activity, duration of maintenance activity, location of maintenance activity, etc.) can be used for specifically tagging computing devices, for which performance parameters have been modified. These and other implementations are explained with respect to FIGS. 3-5.

In an implementation, the performance reports outline an overall view of the workings of these computing devices, typically over a period of time, to ensure that the computing devices are operating in a desirable manner. If a received error or warning warrants a maintenance or replacement of a given device, such an activity can be performed to ensure that uninterrupted operations can continue. In some implementations, the maintenance activities can be pre-scheduled for a specific time period and/or can be scheduled as a regular activity, periodically. In other cases, however, these activities may be scheduled in an ad-hoc manner, since a failure can warrant immediate action, without the opportunity to obtain prior approval and/or generate adequate record keeping for the activities. In situations, performance reports generated for devices under such maintenance can be inaccurate, e.g., owing to the lack of recordkeeping of maintenance activities. That is, if a monitoring system does not store any record of a maintenance of a computing device, the system can simply mark the computing device performance as inadequate during the duration of time the device was under maintenance. This can incorrectly render the device as faulty and/or trigger an unwanted maintenance activity.

In order to ensure that unrecorded events such as maintenance activities are adequately accounted for, when reporting performance parameters for any given device, the implementations described herein provide techniques for maintenance-aware performance reporting. Since the performance insights are generated in real time, but the maintenance windows can be configured at a later point in time, adjusting the performance reports to be aware of maintenance windows configured at a future time, is an important aspect of AIOps based-reporting.

Turning now to FIG. 3, an illustration depicting aggregation of performance data for maintenance-aware reporting is presented. In one implementation, raw performance data 302, e.g., including performance data for one or more computing devices under observation, can be continually received by a management system (e.g., OMS 200 described in FIG. 2). In an example, the performance data can include, without limitation, network management interface data, pipeline services data, time-series data, monitoring tool data, and other AIOps data. As described in FIG. 2, this raw data 302 can be processed by the management system, to generate performance insights to determine operating performance of entities under consideration. The performance insights can further aid in detecting outliers and overall device health for the entities.

In one implementation, the management system is configured to generate performance reports for any given device under monitoring, e.g., responsive to a request from a user device. The performance reports can depict an overall view of all performance parameters generated for the device by the management system. In traditional management systems, reporting of performance data is simply based on collating performance metrics for a given period of time and presenting these metrics to a user device. However, there may be instances wherein the performance data is inaccurate, e.g., owing to missed events such as unconfigured or otherwise unrecorded maintenance windows. Since performance data is obtained and analyzed in real-time, and such maintenance events may be recorded much later than they actually occur, the only manner an “after the fact” adjustment to account for such events can be made, is by reanalyzing the performance data to modify performance parameters, and regenerating the performance reports. Doing so is not only inefficient and expensive, but can further delay decision-making, since report data needs to be recomputed every time an unrecorded event comes to light. Further, it is possible that a given device is be incorrectly flagged by the report and/or incorrectly assigned an unwanted maintenance operation.

In order to tackle these issues, the management system described herein performs a data preparation operation 304, to create data performance databank 306, that can be utilized for easy and efficient modification of performance parameters, in cases where unreported events are to be accounted for. In one implementation, the performance databank 306 is generated such that raw performance data 302 (after being processed and analyzed by the management system) is segregated into individual datasets, each corresponding to stored performance parameters of computing devices for a given duration of time. Further, these datasets are created while maintaining a granularity of metadata generated from the raw performance data 302, wherein each metadata value is indicative of at least one performance parameter (e.g., overall health, remaining lifespan, etc.) associated with a computing device. For example, each dataset in the performance databank 306 corresponds to a specific period of time (equal intervals) and is correlated with metadata generated for a given set of computing devices. The data can further include device indicators, installation location information, device type indicators, and timestamps, amongst others.

In one implementation, each dataset within the performance databank 306 maintains the granularity of metadata, such that performance parameters can be easily identified, even when data is divided into smaller portions to be stored within each dataset. In one implementation, the performance databank 306 can be created using aggregation parameters 308. As shown in the figure, the data preparation operation 304 includes processing the raw performance data 304 to generate performance parameters, and further using aggregation parameters 308 to create the performance databank 306. In some examples, the aggregation parameters 308 include, without limitations, using capabilities to aggregate data at different levels of granularity or detail (i.e., using metadata), as well as aggregation functions, time intervals, sorting parameters, thresholds, and other custom parameters. For example, the performance databank 306 can be generated using correlations between performance parameters and overall device health, for specific time intervals (e.g., 30 minutes or 1-hour intervals). In another example, the performance parameters can be further correlated with device type and device ID. Other implementations are contemplated.

In an implementation, the performance databank 306 is utilized to adjust performance parameters for unrecorded (or erroneously recorded) events, such as maintenance windows, such that accurate performance reports can be generated even when such events are recognized at a later time than they actually occur. The management system is configured to use the metadata associated with specific time interval datasets, from the performance databank 306, to determine performance parameters for one or more computing devices that need to be modified, without requiring to reanalyze their entire performance data. For instance, when a missed maintenance window needs to be configured, at a later time than the maintenance activity was actually performed, the performance databank 306 can be used to efficiently identify generated performance parameters for affected computing devices, for the duration of the maintenance window. Only these parameters can then be modified to account for the configured maintenance window, without altering other details from the overall performance data.

In an implementation, when performance data is initially analyzed for a given computing entity, the data undergoes multiple operations to generate the performance data. In some examples, these operations can include determining types of performance data being analyzed, collating actual values of different types of performance data, assigning weights to each data type, and generating a performance parameter associated with the computing device using the actual values and corresponding weights. For instance, the overall health score (H) for the network interface can be calculated using the following sequence:

H=w₁*T+w₂*PL+w₃*TP+w₄*RP

wherein T denotes a normalized value of network traffic passing through the interface for a given duration of time, PL denotes a normalized value of packet loss for the given duration of time, and TP and RP, respectively denote transmit power and receiving power for the network interface. Further, w₁-w₄ assigned weights to each metric. Other performance parameters can be similarly determined. These implementations are contemplated.

In an implementation, the system determines whether performance parameters are to be adjusted for a given period of time for any given computing device, e.g., based on configuration request received from a user device to configure a previously performed but unreported event. For instance, an administrator can determine that a maintenance activity was performed for a computing device, however, this activity was not recorded into the system at the time (or before) the activity was actually performed. In such scenarios, the administrator can use their user device to send a configuration request to the system to configure the maintenance activity, in an after-the-fact manner, i.e., after the activity has been completed. In an implementation, the system can adjust the performance parameters initially generated for the computed device to account for the newly configured activity, so as to create accurate performance reports.

The performance parameters can be adjusted based on modifying the calculations initially performed to generate the performance parameters. Referring again to the above, there may occur a situation wherein the overall health value (H) initially calculated for the network interface can be deemed inaccurate owing to the configuration of a maintenance activity that involved the network interface. When the system determines that the overall health value (H) is to be corrected to account for the maintenance activity, the system can simply change a calculating methodology for the parameter, without the requirement of reanalyzing the entire performance data. For example, if it is determined that a previously calculated high packet loss value (PL) for the interface is a result of the maintenance activity that was unreported initially, the system can adjust the weight (w₂) assigned to the PL value, without needing to reanalyzing the entire performance data. Since the performance parameters can be easily identified for a given time period from the performance databank 306 (i.e., based on their correlated metadata), the system is able to efficiently access and modify the performance parameters for the duration of time for which the maintenance activity is configured for. This way, even when one or more activities are configured later than they actually occur, the system can dynamically adjust the performance parameters for accurate reporting.

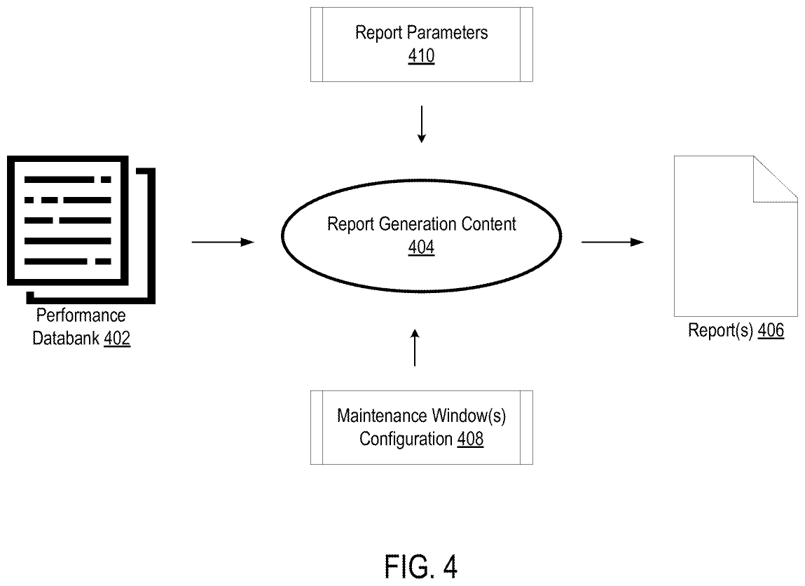

In one implementation, the modifications to the performance parameters for the duration of the maintenance activity can be further extrapolated to perform additional modifications to the performance parameters for other time durations. For instance, if a total surveillance time for a given entity is ‘T’ and the maintenance activity was configured for time ‘t’ the performance parameters is adjusted for the time period t. These modifications can then be extrapolated to seamlessly adjust the performance parameters for time ‘T-t’ without a requirement of reanalyzing or recalculating performance data. In one implementation, the identification of specific performance parameters for a specific period of time is performed using metadata maintained with specific time interval datasets in the performance databank 306. The generation of performance reports using the performance databank is further explained with respect to FIG. 4.

Turning now to FIG. 4, a block diagram depicting generation of performance reports for devices or services under surveillance is shown. As described above, performance databank (e.g., databank 402) is used to create performance reports that can account for unrecorded or erroneous events, recognized at a time later than their actual occurrences. The databank 402 is created by processing raw performance data for computing devices under surveillance to generate performance parameters, and correlating these parameters with metadata for specific intervals of time. In an implementation, these intervals can be generated by dividing the total surveillance time into equal time periods, e.g., 30 minutes or 1-hour intervals.

Any time a report generation request is received from one or more user devices, the system is configured to perform an operation 404 to determine report generation content. The report generation content is then collated together to generate the final report(s) 406. In one implementation, before generating the report(s), the system checks for any maintenance window configurations 408, that may have been unrecorded at the time the performance data was analyzed, but have been since identified. Alternatively, the system can also check for maintenance window configurations 408 that were reported at a previous time, but have been since deemed erroneous. In one implementation, the system can receive ad-hoc maintenance window configurations 408 from various user devices (e.g., administrator devices) located at different geographical locations. Each such configuration 408 can include a request to configure a maintenance activity specifically for computing device(s) installed at their respective geographical locations. The system can be configured to store these requests at a centralized database, and periodically check for new maintenance window configurations 408. In one implementation, some of the maintenance window configurations 408 are representative of maintenance activities that are to be scheduled for a future time, whereas other configurations 408 can represent maintenance activities that occurred in the past, but were unrecorded in the system. In another implementation, these configurations 408 can also be requested to highlight maintenance activities that were erroneously reported but were never performed. This can further include activities other than maintenance activities, such as voluntary shut down or replacement of a device. Other implementations are contemplated.

If such maintenance window configurations 408 are found, the system performs operation 404 by configuring the identified maintenance windows and adjusting the performance parameters of devices affected by these configurations 408. For example, using the performance databank 402, the system can determine a correlation between the time duration for which the maintenance activity is configured for, and the devices that were affected due to this activity (e.g., based on a cumulative time period that each device was under surveillance for). As described above, the system segregates performance parameters corresponding to devices under surveillance, into individual datasets within the performance databank 402. Each dataset is representative of equal time intervals (e.g., 3 datasets of 30 minutes) and stores information associated with the devices (e.g., device ID and site information), and their corresponding performance parameters divided into 30-minute intervals. Whenever a maintenance window configuration 408 is to be performed involving a given device, the system can select a dataset(s) storing performance parameters for the device for the total duration of the maintenance activity, as identified from the maintenance window configuration 408. This selection is made based on matching a duration of the maintenance activity with a time interval represented by each dataset.

In an implementation, since metadata identifying each performance parameter is maintained in each dataset of the performance databank 402, the system is able to identify performance parameters generated for the device at the time performance data was analyzed for the device. Selected ones of these performance parameters can then be modified to account for the maintenance window configurations 408, without requiring reanalysis of the performance data for the device. In one implementation, the modifications to the performance parameters, made for the duration of the maintenance activity, can further be extrapolated to perform additional modifications to performance parameters for the remaining time of surveillance (i.e., maintenance window duration deducted from the total surveillance time).

In one implementation, the system modifies the performance parameters for entities, e.g., by adjusting values of performance parameters based on the maintenance window configurations 408. For example, a device that was initially marked as being operating with an overall health of 50 percent and with a remaining lifespan of 150 days, can be remarked as operating with an overall health of 75 percent and with a remaining lifespan of 200 days, in response to a determination that a maintenance activity was performed for the device at the time these parameters were calculated, however, this activity was only reported later. In another implementation, the system can unmark devices that were erroneously marked as faulty, but were instead under an unrecorded maintenance. Further, the performance parameters can be modified each time maintenance window configurations 408 are identified for maintenance or other activities that were unrecorded or otherwise unrecognized by the system in real-time or near real-time. The adjustments to the performance parameters can be made at the time maintenance window configurations 408 are recorded into the system. In another implementation, the adjustments can be made when the system checks for maintenance window configurations, e.g., in response to a report generation request received from a user device.

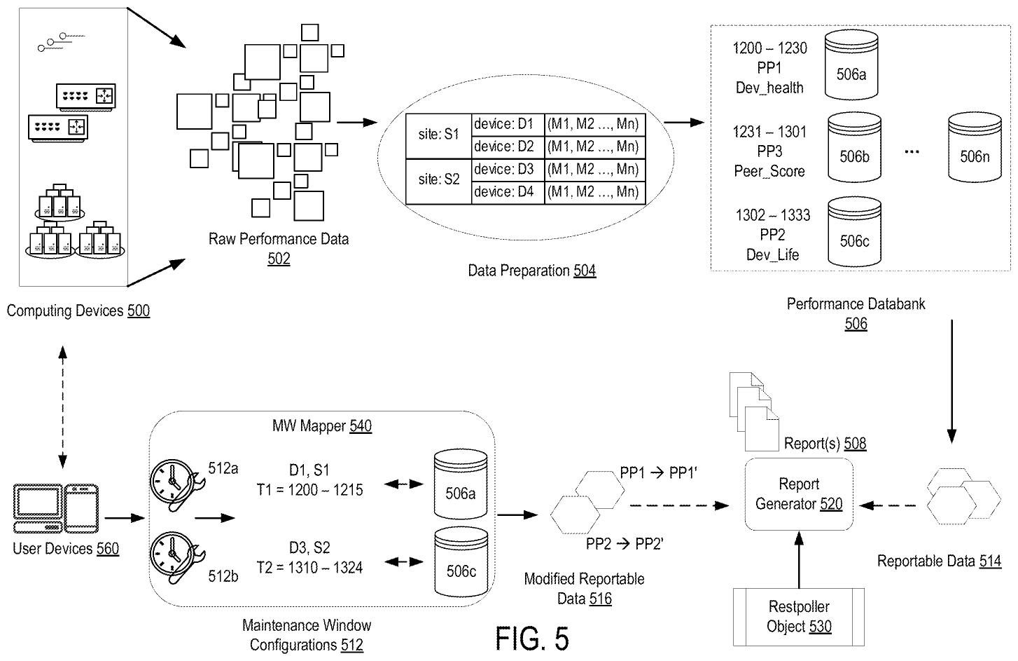

In an implementation, the operation 404 further includes using report parameters 410 to generate the final report(s) 406. The report parameters 410 can include, without limitation, time ranges, metrics and KPI data, data source information, thresholds, customization options, and the like. Based on these reporting parameters 410 and the configured maintenance windows (or other events), the system can generate the report(s) 406 in real-time, e.g., in response to a request from a user device. Further, each time a new maintenance window configuration 408 is to be performed, the system can modify the performance parameters and regenerate the report content. In an implementation, each time new maintenance activities or other events are configured, the system can also notify a user device of the same, and present an option to access updated report(s) 406. A detailed example of modifying report data based on maintenance window configurations is described in FIG. 5.

FIG. 5 illustrates a block diagram depicting modification of report content based on maintenance window configuration. As shown in the figure, raw performance data 502 including metric data from various computing devices 500 under surveillance is received, and undergoes a data preparation operation 504. The data preparation operation 504, in one implementation, includes processing and analyzing raw performance data 502 to generate performance parameters for the computing devices 500. The data preparation operation 504 further includes correlating metadata gleaned from the raw performance data 502, along with their respective receipt times, in order to create performance databank 506. The metadata values define performance parameters generated by analyzing the performance data 502. As described in the foregoing, performance databank 506 is created to segregate the processed performance data into datasets corresponding to predetermined equal intervals, such that the granularity of metadata is maintained within each dataset.

As depicted in the figure, the performance data is first divided using various identifiers, e.g., installation site identifier and device ID, and metric data for each device installed in each site is generated. In the example shown, for site S1, metric data (denoted by ‘M1-Mn’) is generated for devices D1 and D2. Similarly, site S2, metric data is collected for devices D3 and D4. The metric data, in one implementation, is further processed to generate performance parameters. For example, for an optical transceiver, metric data associated with Tx and Rx powers, operating current and voltage, and temperature can be processed to generate an overall health score for the transceiver. Similarly, for any given network node, network traffic and bandwidth data for can be used to determine a remaining life of the network node. Other implementations are possible.

In one implementation, the performance parameters for computing devices 500 under surveillance are stored in performance databank 506. The performance databank 506 is generated in a manner that the performance parameters generated over a period of time (e.g., total surveillance time) is divided into smaller portions of data (e.g., divided into 30 minute portions) and stored in distinct datasets. Each such dataset corresponds to a given interval of time, and maintains metadata associated with computing devices 500, that identify the performance parameters stored therein.

In the example shown, the performance databank 506 is generated with multiple datasets 506a-n, each corresponding to 30-minute time intervals. These datasets are denoted as such. In one example, for any given day, dataset 506a stores performance parameters generated between time 1200 hours to 1230 hours, dataset 506b stores performance parameters generated between time 1231 hours to 1301 hours, and so on. In one instance, metric data M1 for device D1 is recorded at a time 1225 hours, a given performance parameter (“PP1”) corresponding to metric M1 is stored in the dataset 506a. Further, dataset 506a is associated with metadata ‘dev_health,’ indicating that the performance parameter PP1 stored in the dataset corresponds to the overall device health of the device D1. Similarly, metric data M3 for device D2 is placed in dataset 506c, as it is received at 1305 hours. Dataset 506c is associated with metadata ‘peer_score,’ indicating that the performance parameter PP3 stored in the dataset corresponds to the peer score of the device D2, as calculated using metric data M3. For the sake of simplicity, only a single performance parameter is shown to be associated with each dataset. However, it is noted that network management systems can generate numerous performance parameters for each device 500 under surveillance, and each such performance parameter, correlated with metadata, can be stored in any given dataset, as explained herein. Each metric data, for each device 500 under surveillance, is similarly placed in one of the datasets in the performance databank 506. Based on the metric data, corresponding performance factors, and metadata, the system generates reportable data 514.

The report generator 520, in one implementation, is configured to access the reportable data 514 to generate performance report(s) 508. The report(s) 508 can be generated in response to a request from a user device 560 (e.g., system administrator) or can be periodically generated and issued to various personnel devices. In an implementation, the report generator 520 further uses a “RESTpoller object” 530 to generate the report(s) 508. The RESTpoller object 530, as described herein, is a REST (Representational State Transfer) object for networked applications, used in web services development. The RESTpoller object 530 can use HTTP requests to perform CRUD (Create, Read, Update, Delete) operations on resources, often utilizing endpoints (URLs) to access these resources. The system can use the RESTpoller object 530 to repeatedly access a server or dataset storing report parameters (e.g., report parameters 410 of FIG. 4) to generate the report(s) using the reportable data 514.

In one implementation, several maintenance windows 512 can be configured for the devices 500 under surveillance, anytime during analysis of performance data 502 by the system. As depicted in the figure, one or more maintenance windows 512 (collectively referred to as maintenance windows 512), can be configured at any given time by individual user devices 560. According to an implementation, these maintenance windows can be configured for any number of computing devices 500, for any durations of time. Responsive to a maintenance window configuration request from a user device 560, the system can simply schedule the maintenance window 512 for a desired time. Further during the time these maintenance windows 512 are configured for, the affected computing devices 500 are marked as being under maintenance. The performance data 502 from these devices 500 is analyzed accounting for the configured maintenance windows 512. For example, during maintenance, some or all of the performance metrics for the device 500 may either be unavailable or inaccurate for the duration the device 500 is under maintenance. The system can take the lack of or otherwise inaccurate metrics into account when performance report(s) 508 is generated for the device 500.

However, in some implementations, there may be instances wherein a maintenance window 512 is configured after the maintenance activity has already taken place. For example, there may be situations wherein an administrator is unable to record the maintenance activity into the system, owing to lack of opportunity to obtain prior approval and/or generate adequate record keeping for the activities. In other instances, it can also be possible that one or more devices 500 that were erroneously marked as being under maintenance, did not undergo any maintenance. In either situation, the performance data generated by the device 500 would not present an accurate analysis of the performance of the device 500, since the system is unaware of these maintenance windows 512. In order to account for such maintenance windows 512, the system generates modified reportable data 516 to account for such maintenance windows 512.

In the example shown in the figure, one or more maintenance windows 512 can be configured in an after-the-fact manner. In one implementation, maintenance window mapper (MW mapper) 540 correlates maintenance window data with individual datasets from the performance databank 506. For example, maintenance window 512a is configured for device D1 at installation site S1 and is configured for a duration of time T1. As shown, the duration of maintenance window 512a (given by ‘T1’) is 15 minutes from 1200 hours to 1215 hours, the MW mapper 540 can correlate the maintenance window 512a to dataset 506a, since 506a corresponds to performance parameters stored for time between 1200 hours to 1230 hours. Based on this correlation, the MW mapper 540 flags the data for device D1 initially stored in the dataset 506a, and updates the performance parameters in reportable data 514, e.g., to generate modified reportable data 516. Similarly, maintenance window 512b (device D3 at site S2) is correlated with dataset 506c. In an implementation, the correlation is performed by matching the duration of the maintenance window with the time interval corresponding to each dataset in the performance databank 506.

In one implementation, the performance parameters to be modified, e.g., to account for maintenance windows 512, can be selected by the system based on one or more factors, such as, type of device, installation site, user configuration settings, and/or other preferences. For example, if the system determines that overall health of the device D1 is to be adjusted in order to account for the maintenance window, the system can identify performance parameter data stored in the dataset 506a that corresponds to the overall health score of the device D1. In one implementation, this can be done based on the metadata maintained in each dataset (in this case data supplemented with the tag “dev health” is selected). The selected performance parameter PP1, can then be modified to generate parameter PP1′, e.g., by modifying one or more inputs and/or weights used by the system to originally calculate the performance parameter PP1. This modified data is then stored as modified reportable data 516. Similar modifications can be made for each device 500 affected by configuration of maintenance windows 512. For instance, for device D3, performance parameter PP2 is modified to parameter PP2′.

In an implementation, original performance parameters (i.e., stored in reportable data 514) can be flagged, indicating that updated data is available. The flagging of the original data can include storing a notification or tag stating that performance insights associated with a given device 500, are inaccurate or outdated. Further, based on the modified reportable data 516, the originally stored data in performance databank 506 can also be modified. In one implementation, the report generator 520 can generate the performance report(s) based on one of the original reportable data 514 or updated reportable data 516. In one example, original reportable data 514 is used to generate the report(s) 508, when the system determines that no maintenance windows 512 are to be configured at the time a report generation request is received from a user device 500. Further, modified reportable data 516 is used to generate the report(s) 508, when the system determines that one or more maintenance windows 512 are to be configured, at the time a report generation request is received from a user device 500, wherein the duration of the maintenance window 512 overlaps or is subsumed within a duration of time for which the report is sought. In another implementation, the system can periodically check for maintenance windows 512, even when no report generation requests are made.

Further, original reportable data 514 can also be modified if a maintenance window 512 was erroneously configured in real-time and therefore affected a performance parameter(s) for a given device 500. That is, the modifications to specific performance parameters, i.e., only data affected by the maintenance window configuration, can be made in an “after the fact” manner, without requiring other data to be changed. Furthermore, these modifications can be done without the need of any further analysis (or reanalysis) of the raw performance data 502.

The solutions presented herein provide the ability to allow configuration of events at any point in time (even after the events have been initiated and/or completed), and adjust the performance reporting to reflect these events. Additionally, the system is able to tag the originally generated performance parameters to clearly indicate a reason for updates to the parameters. The analyzed data can further be optimized for storage in the form of performance databank.

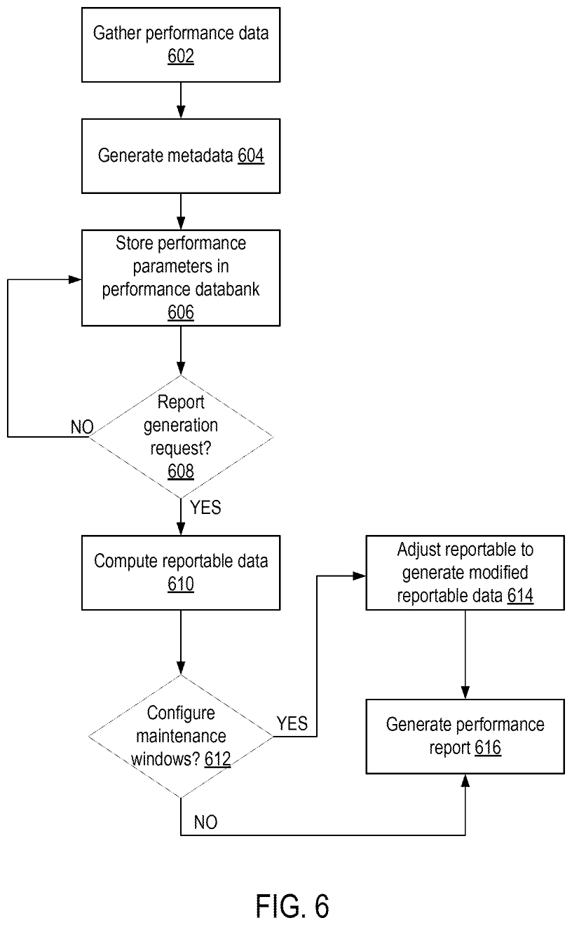

FIG. 6 illustrates a method for maintenance-aware performance reporting. As described in the foregoing, performance data, such as data pertaining to events, errors, warnings, anomalies, etc. associated with various devices (e.g., datacenters, network devices, servers, virtual machines, etc.) can be reported to user devices in the form of performance reports. These reports outline performance data and are generated to provide an end-user an overall view of the workings of these devices, typically over a period of time, to ensure that the devices are operating in a desirable manner. If a received error or warning warrants a maintenance or replacement of a given device, such an activity can be performed to ensure that uninterrupted operations can continue.

In one implementation, an operations management system (or OMS) can continually gather raw performance data from devices under surveillance (block 602). The raw performance data, in one implementation, can include metric data associated with the devices under monitoring. For example, for an optical transceiver, this data can include transmit and receive powers, bias current, bit error rates, and the like. In another example, for network devices, the performance data can include bandwidth utilization, packet loss, latency, and the like. In one implementation, the raw performance data is processed and analyzed to generate performance parameters associated with the devices.

In one implementation, the OMS is configured to generate metadata associated with the performance parameters (block 604), such that the metadata values identify each performance parameter. In one example, the metadata tags include, without limitation identify parameters such as device health, device ratings, device lifespan and the like. Based on these metadata values, the OMS is configured to store performance parameters in a performance databank (block 606). In an implementation, the performance databank comprises of distinct datasets, each corresponding to equal time intervals, and are created in a manner that a granularity of each metadata (defining the performance parameters) is maintained in each dataset. For example, performance parameters segregated into each dataset is infused with the metadata values, such that the performance parameters can be easily identified even when the data is divided into the smaller portions based on predefined time intervals (e.g., 30 minutes).

In an implementation, receipt of a report generation request can be determined by the OMS (conditional block 608), e.g., when the report generation request is received from a user device. In one example, reports can be requested by personnel devices to access an overall view of performance of the various computing devices under surveillance. If a report generation request is received (conditional block 608, “yes” leg), the OMS can compute reportable data (block 610). In an implementation, the reportable data includes data requested by the user device, e.g., data filtered for a given time period, data requested for specific devices, specific performance metrics requested by the user device, and the like.

In one implementation, when the reportable data is computed, the OMS can check for any maintenance windows that need to be configured for a device(s), within the duration of time the report has been requested for (conditional block 612). If the OMS determines that a maintenance window needs to be configured (conditional block 612, “yes” leg), the maintenance window is configured, and the reportable data is modified accordingly (block 614). In one implementation, maintenance windows can be configured for one or more maintenance operations, e.g., a previously scheduled but unrecorded maintenance activity to be accounted for or to flag an erroneously reported maintenance activity (wherein no maintenance was actually performed).

In one implementation, when such maintenance windows are configured, the reportable data is modified to account for these maintenance activities, such that the performance reports include accurate and up-to-date data. The reportable data, in one example, is modified by changing performance parameters for the duration of time the maintenance window was scheduled (or was erroneously reported for), whilst keeping other parameters and data unchanged. This aids in updating reportable data, “on-the-fly” for any previously scheduled but unreported maintenance. Further, since the update is done without reanalysis of the entire performance data, efficiency and accuracy of report generation is maintained.

In an example, the reportable data is adjusted by first selecting one or more performance parameters that are to be adjusted for the affected device(s). Further, data corresponding to these parameters is identified based on metadata stored within the performance databank. For example, the performance parameters to be adjusted are identified based on metadata identifying the performance parameters, that are stored in a dataset for the duration of the configured maintenance window. That is, the performance parameters are adjusted by correlating an actual time and duration of a configured maintenance window, with a dataset(s) storing data corresponding to that time, wherein the data includes performance parameters. The performance parameters that are to be adjusted can be identified using associated metadata.

For example, if a dataset stores performance parameters generated for a device from time T1 to time T3 (e.g., 60 minutes), and a maintenance window is configured for duration between time T2 to T3 (e.g., 30 minutes), parameters corresponding to the time between time T2 and T3 are adjusted to account for the maintenance window, without changing other data recorded for time T1 to T2. In an alternative implementation, these modifications can be used to extrapolate additional modifications in performance parameters recorded outside of the time between T1 and T3. Further, this can be done even when the maintenance window is configured at a time much later than time T3. Based on these modifications to the reportable data, the OMS can generate and present the performance report(s) (block 616).

In an implementation, the OMS is configured to periodically check for maintenance windows that need to be configured. Whenever such windows are configured, the OMS can send a notification to one or more user devices, indicating that updated performance reports are available. Further, each time the reportable data is updated, the OMS can flag the modifications to the data for ease of review. In case no such maintenance windows are to be configured (conditional block 612, “no” leg), the OMS can simply generate the performance reports using the originally created reportable data (block 616).

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a processing unit configured to:
store performance related data of at least one computing device corresponding to a first period of time;
modify, at a given point in time outside of the first period of time, the performance related data to change a number of events identified as having occurred during the first period of time; and
generate a performance report based on the performance related data as modified at the given point in time.

2. The system as claimed in claim 1, wherein the processing unit is configured to modify, at the given point in time, the performance related data responsive to a request for generation of the performance report associated with the at least one computing device for the first period of time.

3. The system as claimed in claim 2, wherein the processing unit is configured to modify, at the given point in time, the performance related data responsive to a request requesting configuration of one or more events, corresponding to the at least one computing device, for a second period of time subsumed within the first period of time.

4. The system as claimed in claim 2, wherein the processor unit is further configured to extrapolate the modification to the performance related data to perform, at the given point in time, one or more additional modifications to the performance related data for a third period of time outside of the first period of time.

5. The system as claimed in claim 1, wherein the processing unit is configured to:
store performance related data of the at least one computing device corresponding to the first period of time in a performance databank comprising of a plurality of datasets each corresponding to equal time intervals;
correlate the given point in time with each dataset of the plurality of datasets to select one or more datasets; and
modify, at the given point in time, the performance related data stored in the selected one or more datasets.

6. The system as claimed in claim 1, wherein the processing unit is configured to:
generate metadata identifying the performance related data of the at least one computing device; and
modify, at the given point in time, the performance related data at least based in part on the generated metadata.

7. The system as claimed in claim 1, wherein the processing unit is configured to generate, at the given point in time, the performance report at least based in part on originally stored performance related data.

8. A method comprising:
storing, by a network management system, performance related data of at least one computing device corresponding to a first period of time;
modifying, by the network management system, at a given point in time outside of the first period of time, the performance related data to change a number of events identified as having occurred during the first period of time; and
generating, by the network management device at a graphical user interface corresponding to a user device, a performance report based on the performance related data as modified at the given point in time.

9. The method as claimed in claim 8, further comprising modifying, by the network management system at the given point in time, the performance related data responsive to a request for generation of the performance report associated with the at least one computing device for the first period of time.

10. The method as claimed in claim 9, further comprising modifying, by the network management system at the given point in time, the performance related data responsive to a request configuration one or more events corresponding to the at least one computing device for a second period of time subsumed within the first period of time.

11. The method as claimed in claim 9, further comprising extrapolating, by the network management system, the modification of the performance related data to perform, at the given point in time, one or more additional modifications to the performance related data for a third period of time outside of the first period of time.

12. The method as claimed in claim 8, further comprising:
storing, by the network management system, performance related data of the at least one computing device corresponding to the first period of time in a performance databank comprising of a plurality of datasets each corresponding to equal time intervals;
correlating, by the network management system, the given point in time with each dataset of the plurality of datasets to select one or more datasets; and
modifying, by the network management system at the given point in time, the performance related data stored in the selected one or more datasets.

13. The method as claimed in claim 8, further comprising:
generating, by the network management data, metadata identifying the performance related data of the at least one computing device; and
modifying, by the network management data, at the given point in time, the performance related data at least based in part on the generated metadata.

14. The method as claimed in claim 8, further comprising generating, by the network management system at the given point in time, the performance report at least based in part on originally stored performance related data.

15. A system comprising:
a data analyzer configured to:
store performance related data of at least one computing device corresponding to a first period of time;
a report generator configured to:
modify, at a given point in time outside of the first period of time, the performance related data to change a number of events identified as having occurred during the first period of time; and
generate a performance report based on the performance related data as modified at the given point in time.

16. The system as claimed in claim 15, wherein the report generator is configured to modify, at the given point in time, the performance related data responsive to a request for generation of the performance report associated with the at least one computing device for the first period of time.

17. The system as claimed in claim 16, wherein the report generator is configured to modify, at the given point in time, the performance related data responsive to a request configuration one or more events corresponding to the at least one computing device for a second period of time subsumed within the first period of time.

18. The system as claimed in claim 16, wherein the report generator is further configured to extrapolate the modification of the performance related data to perform, at the given point in time, one or more additional modifications to the performance related data for a third period of time outside of the first period of time.

19. The system as claimed in claim 15, wherein the report generator is configured to:
store performance related data of the at least one computing device corresponding to the first period of time in a performance databank comprising of a plurality of datasets each corresponding to equal time intervals;
correlate the given point in time with each dataset of the plurality of datasets to select one or more datasets; and
modify, at the given point in time, the performance related data stored in the selected one or more datasets.

20. The system as claimed in claim 1, wherein the report generator is configured to:
generate metadata identifying the performance related data of the at least one computing device; and
modify, at the given point in time, the performance related data at least based in part on the generated metadata.
